(19) United States
(12) Patent Application Publication
(10) Pub. No.: US 2016/0348632 A1
(43) Pub. Date: Dec. 1, 2016

(54) ASSEMBLY COMPRISING A HEAT ENGINE AND AN ELECTRICAL COMPRESSOR

(71) Applicant: VALEO SYSTEMES DE CONTROLE MOTEUR, Cergy Saint Christophe (FR)

(72) Inventors: Florent David, Suresnes (FR); Sébastien Potteau, Triel Sur Seine (FR); Jean-Baptiste Siegwart, Pontoise (FR)

(73) Assignee: Valeo Systemes de Controle Moteur, Cergy Saint Christophe (FR)

(21) Appl. No.: 15/106,593

(22) PCT Filed: Dec. 18, 2014
(86) PCT No.: PCT/FR2014/053420

§ 371 Date: Aug. 23, 2016

(30) Foreign Application Priority Data
Dec. 19, 2013 (FR) 1362998

(51) Int. Cl. F02P 5/15; F02B 29/04; F02B 37/12; F02B 33/34; F02B 39/10; F02B 37/04

(52) U.S. Cl. CPC F02P 5/15; F02B 39/10; F02B 37/04; F02B 37/127; F02B 33/34; F02B 29/04

(57) ABSTRACT

The present invention concerns an assembly (1) comprising: an intake duct (4) extending between an air inlet (11) and a heat engine (2), a heat engine (2), an electric compressor (5) disposed on the intake duct and upstream from the heat engine (2), the electric compressor (5) being configured to allow the spark advance to be degraded during a transitory phase.

The present invention relates to the field of spark ignition engines and more particularly to an assembly for a heat engine of an automobile comprising an air intake system and an electric compressor configured to increase the degradation of the spark advance.

During cold starts, spark-ignition engines generate more polluting emissions, such as unburned hydrocarbons, carbon monoxide or nitrogen oxides (NOx), particularly due to the combustion at a lower temperature, the condensation of the fuel and the local quenching of the flame on the cold walls, which are not able to be post-treated by the catalyst, whose action only begins starting at about 350° C.

Given that the future cycle for vehicle certification, or WLTC (Worldwide harmonized Light-duty vehicles Test Cycle), is more dynamic than the current one, the need exists today to reduce polluting emissions and fuel consumption even more in order to meet future standards. This entails a need to reduce the catalyst activation time. This task of seeking an improvement particularly involves the transitory phases of the operation of the engine, such as start-up, gear-shifting, braking or engine shutdowns.

One solution for reducing this generation of unburned hydrocarbons during vehicle start-up is to implement a warm-up phase for the engine, which, by increasing the exhaust temperature, enables the catalyst to function more efficiently and quickly. One drawback of this technique arises from the fact that the warm-up phase is very costly in that it uses a great amount of fuel.

To reduce the duration of this catalyst activation phase, the current solution being used in gasoline engines is to degrade the spark advance and to compensate for this degradation by means of an increase in the amount of the air intake in order to achieve the engine torque desired by the driver.

However, in transitory states with high loads, that is, when the driver accelerates suddenly, the air intake quantity does not increase immediately. This phenomenon is particularly noticeable in an engine equipped with a turbocharger. After all, the turbocharger can exhibit a certain lag in response (turbo lag), periods of time in which the enthalpy of the exhaust gas is not yet sufficient to cause the turbine of the turbocharger to turn at the ideal engine speed.

To compensate for this response time, one solution consists in reducing the degradation of the spark advance. This reduction of the degradation of the spark advance enables the effective torque to be increased while waiting for the air quantity to be sufficient to enable advance degradation. This reduction of the degradation puts a stop to the generation of the high exhaust temperature required for the proper treatment of unburned residues. This solution results in elevated polluting emissions.

To compensate for this, it is necessary to
incorporate more precious metals into the catalyst so as to improve the efficiency, which involves a non-negligible additional cost, and
install the catalyst as close as possible to the engine outlet in order to limit the thermal losses in the ducts, which causes difficulties with integration and mean thermal stresses that are greater on the catalyst during hot operation. The latter effect results in the accelerated aging of the catalyst, which negates the benefit of the increase in precious metals.

It is therefore the object of the present invention to address one or more of the drawbacks of the systems of the prior art by proposing an assembly for a heat engine comprising an electric compressor enabling improvement both in terms of polluting emissions and fuel consumption during the use of the vehicle.

For this purpose, the present invention proposes an assembly comprising:
an intake duct extending between an air intake and a heat engine,
a heat engine,
an electric compressor disposed on the intake duct upstream from the heat engine,
   the electric compressor being configured so as to enable the spark advance to be degraded during a transitory phase.

According to one embodiment of the invention, the electric compressor is equipped with a variable reluctance motor.

The electric compressor thus enables the flow of intake air to be increased more rapidly, which limits the increase in advance efficiency, reduces the warm up time of the engine and thus enables polluting emissions to be reduced and future certification cycles to be complied with.

According to one embodiment of the invention, the assembly comprises at least one valve disposed upstream from the heat engine and downstream from the electric compressor and regulating the flow of intake air in the heat engine.

According to one embodiment of the invention, the electric compressor is integrated into a bypass circuit comprising bypass means configured to conduct the intake air through the electric compressor during a transitory phase.

According to one embodiment of the invention, the assembly comprises a heat exchanger disposed on the intake duct.

According to one embodiment of the invention, the electric compressor is disposed upstream from the heat exchanger and upstream from the valve.

According to one embodiment of the invention, the electric compressor and the valve are disposed upstream from the heat exchanger.

The invention also concerns a method for controlling an assembly according to the invention, comprising, during a transitory phase:
a stage in which the electric compressor is activated,
a stage in which intake air is circulated through the electric compressor,
a spark advance degradation stage.

According to one embodiment of the invention, the method comprises a stage in which the flow of the intake air is regulated with a valve.

The invention also concerns the use of the assembly according to the invention for degrading the spark advance during a transitory phase.

According to one embodiment of the invention, the transitory phase is a start-up phase.

Other aims, features and advantages of the invention will be better understood and will become clearer upon reading the description which follows, in which reference is made to the enclosed drawings, which are provided for the sake of example and in which:

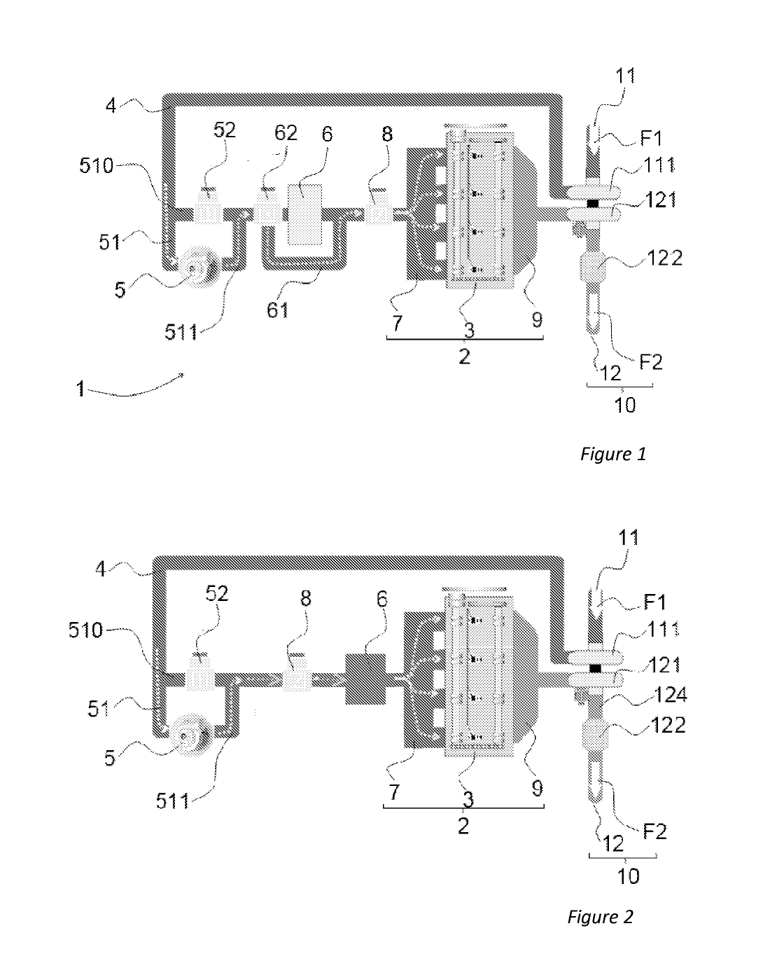

FIG. 1 is a schematic and partial representation of an engine architecture involving an electric compressor according to the invention according to a first variant of the invention,

FIG. 2 is a schematic and partial representation of an engine architecture involving an electric compressor according to the invention according to a second variant of the invention,

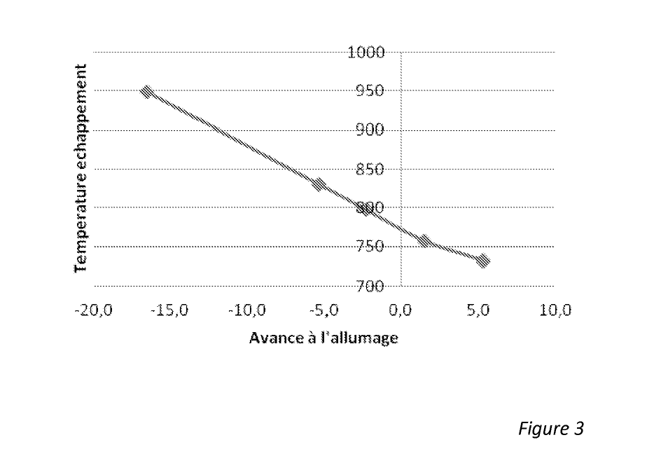

FIG. 3 is a representation of the results obtained during the use of the device according to the invention.

The present invention relates to an assembly comprising a heat engine, an air intake system and an electric compressor.

The present invention concerns the set of the heat engines, fuels, gases, ethanol, or a mixture of these constituents, whether supercharged or not.

In the description, an electric compressor is understood as being an air compressor, whether volumetric or not, for example centrifuge or radial, driven by an electric motor for the purpose of supercharging a heat engine.

According to one embodiment of the invention, the compressor is an air supercharger.

According to one embodiment of the invention, the electric motor of the electric compressor is a DC or AC current motor that is synchronous or of any kind of electric motor of the same type.

More precisely, according to one embodiment of the invention, the electric motor is a variable reluctance motor (also called switched reluctance motor, or SRM).

The electric compressor is therefore generally activated in order to increase the density of the intake air. In the context of the invention, the electric compressor is associated with a bypass circuit (also called a shunt circuit) that enables it to be bypassed as necessary, as will be described further below in the description.

In the context of the invention, the electric compressor is disposed upstream from the heat engine.

According to one embodiment of the invention, the heat engine is a two-stroke heat engine.

According to another embodiment of the invention, the heat engine is a four-stroke heat engine.

The assembly according to the invention comprises at least one catalyst disposed at the outlet of the heat engine on the exhaust line.

According to one embodiment of the invention, the assembly comprises several catalysts.

In the context of the invention, the electric compressor is used during the transitory phases of engine use. The electric compressor thus enables the flow of intake air to be increased more rapidly, which limits the increase in advance efficiency. This limitation of the increase in advance efficiency results in greater advance degradation and thus to greater exhaust temperatures. The exhaust temperature increases more quickly, as does the catalyst temperature.

The use of the electric compressor offers the advantage of reducing the warm-up time of the engine. This makes it possible to reduce reliance on precious metals in the catalyst and to limit its thermal stresses by installing it farther away on the exhaust line.

The use of the electric compressor thus enables polluting emissions to be reduced and future certification cycles to be complied with.

In the context of the invention, a transitory phase is understood as the phase of operation of the engine at start-up, and more precisely during engine warm up.

The engine assembly 1 of the present invention, an embodiment of which is illustrated in FIGS. 1 and 2, comprises a heat engine 2 with an intake duct 4 and an electric compressor 5.

This engine 2 comprises an engine block 3 comprising a plurality of cylinders—four in the figure—intended to receive a mixture of oxidizer and fuel, with gasoline being an example of a fuel and pure air or an air/recirculated gas mixture being an example of an oxidizer.

The combustion in the cylinders generates the work of the engine 2. The engine 2 functions in a standard manner: Air is admitted into the cylinders, burned there and then expelled in the form of exhaust gas.

This engine 2 has an intake connected to the intake duct 4 and an outlet connected to gas exhaust system 10.

The intake of the intake duct 4 defines the inlet through which the fresh intake air penetrates into the assembly 1, whereas the outlet 12 of the exhaust system 10 defines the outlet through which the exhaust gases are removed from the assembly

The intake duct 4 leads to an intake manifold 7, which thus forms an intake box for the intake air in the combustion chamber 3 of the engine 2.

An intake duct 4 is understood as a conduit for letting the intake air in, the flow of which is represented by the arrow F1, this conduit being situated between the air intake 11 and the engine 2.

According to one embodiment of the invention, the intake duct 4 comprises a mechanical intake air compressor 111.

According to one embodiment of the invention, the intake duct 4 comprises a heat exchanger 6, also called a charge air cooler, thus enabling the intake air and, for example, the air from the mechanical compressor 111 to be cooled. The heat exchanger 6 enables a thermal exchange between the intake air and the coolant of the heat exchanger 6. At the outlet of the heat exchanger 6, the gases are at a temperature near that of the coolant of the heat exchanger 6. This heat exchanger can be an air/air or air/water heat exchanger.

According to one embodiment of the invention, upstream from the intake manifold 7 allowing air into the engine 2, the intake duct 4 comprises a valve 8 comprising a butterfly-type valve whose function it is to control the flow of the intake air in order to regulate the engine speed. This valve 8 is controlled by an engine control unit (ECU), which is well known to a person skilled in the art, and enables the quantity of air introduced into the engine and required for combustion to be regulated.

The outlet of the engine 2 is formed by an exhaust gas manifold 9. The latter is connected to a gas exhaust line or gas exhaust pipe 124 forming part of the gas exhaust system.

According to one embodiment of the invention, the exhaust system 10 comprises a turbine 121, which is integral in rotation with the mechanical intake air compressor 111 and forms a turbocharger therewith. The turbine 121 is driven by the exhaust gases from the exhaust line 124, the flow of which is shown schematically by the arrow F2. According to one embodiment, the flow traverses the catalyst 122.

As illustrated in FIG. 1, the assembly 1 comprises an electric compressor 5. This compressor 5 is driven by an electric motor (not shown) that is controlled, for example, by the motor control unit. The electric compressor 5 is disposed in the mouth of the intake duct 4.

In a first variant of the invention, the electric compressor 5 is disposed upstream from the heat exchanger 6, which is itself disposed downstream from the butterfly valve 8.

In a second variant of the invention, the electric compressor 5 is disposed upstream from the butterfly valve 8, which is itself disposed upstream from the heat exchanger 6.

According to one embodiment of the invention, the electric compressor is integrated into a bypass circuit 51 (also referred to as a shunt circuit) comprising a valve-type bypass means 52. This valve 52 is a butterfly valve, for example. This valve 52 is controlled, for example, by a control unit of the engine. In combination with the bypass means 52, the bypass circuit 51 generally enables the air taken in via the intake system 4 to circulate through the electric compressor or to bypass it, through the closing or opening of the bypass means 52. The valve-type bypass means 52 is disposed on a first conduit 510 of the bypass circuit 51 different from that of the electric compressor 5, so that, when the valve is closed, the intake air is conducted toward the second conduit 511, where the electric compressor 5 is disposed.

Accordingly, outside of the engine operation phases in which the compressor is used, and, in the context of the invention, outside of the transitory phases, the intake air circulates in the first conduit 510 and does not traverse the electric compressor 5.

The assembly according to the invention functions as follows.

During a transitory phase, the electric compressor is activated via the engine control unit and compresses the intake air circulating in the intake duct.

This compressed air is then sent either directly to the engine via the heat exchanger 6 and then the butterfly valve 8 or via the butterfly valve 8 and then the heat exchanger 6.

The transitory phase can then be followed by an established phase according to which the assembly is controlled in such a way that the electric compressor is not fed.

This method for controlling an assembly as defined above thus makes it possible during a transitory phase to activate the electric compressor and, with the aid of the same, compress all or part of the intake air circulating in the intake duct, which enables the airflow in the engine to be increased more rapidly.

The results shown in FIG. 3 illustrate the increase in the exhaust temperature as a function of the spark advance. Therefore, the more the advance is degraded, the greater the exhaust temperature, which enables the catalyst to be heated more quickly.

The use of the electric compressor thus makes it possible to obtain more airflow, which allows the iso engine torque to have more advance degradation and thus to increase the temperature of the exhaust gases. The other effect is an increase in the intake airflow and thus of the exhaust enthalpy with quicker heating of the catalyst or catalysts.

The reduction of the duration of the activation of the catalyst results in a decrease in pollutants and an improvement in fuel consumption.

The scope of the present invention is not limited to the details given above and allows for embodiments in numerous other specific forms without leaving the area of application of the invention. Consequently, the present embodiments must be regarded as being for purposes of illustration and can be modified without leaving the scope defined by the claims.

1. An assembly comprising:
an intake duct extending between an air intake and a heat engine;
the heat engine; and
an electric compressor disposed on the intake duct upstream from the heat engine;
the electric compressor being configured so as to enable the spark advance to be degraded during a transitory phase.

2. The assembly as claimed in claim 1, comprising at least one valve disposed upstream from the heat engine and downstream from the electric compressor and regulating the flow of intake air in the heat engine.

3. The assembly as claimed in claim 1, wherein the electric compressor is integrated into a bypass circuit comprising bypass means configured to conduct the intake air through the electric compressor during a transitory phase.

4. The assembly as claimed in claim 1, comprising a heat exchanger disposed on the intake duct.

5. The assembly as claimed in claim 4, wherein the electric compressor is disposed upstream from the heat exchanger and upstream from the valve.

6. The assembly as claimed in claim 4, wherein the electric compressor and the valve are disposed upstream from the heat exchanger.

7. The assembly as claimed in claim 1, wherein the electric compressor is equipped with a variable reluctance motor.

8. A method for controlling an assembly as claimed in claim 1 comprising, during a transitory phase:
a stage in which the electric compressor is activated;
a stage in which intake air is circulated through the electric compressor;
a spark advance degradation stage.

9. The method as set forth in claim 8, comprising a stage in which the intake airflow is regulated with a valve.

10. A use of the assembly as claimed in claim 1, for degrading the spark advance during a transitory phase.

11. The use of the assembly as claimed in claim 10, the transitory phase being a start-up phase.
